(19) United States
(12) Patent Application Publication
(10) Pub. No.: US 2021/0136068 A1
(43) Pub. Date: May 6, 2021

(54) TELECOM NODE CONTROL VIA BLOCKCHAIN

(71) Applicant: Telefonaktiebolaget LM Ericsson (publ), Stockholm (SE)

(72) Inventors: Bernard SMEETS, DaIby (SE); Alexander PANTUS, Solna (SE); Jonathan OLSSON, Sollentuna (SE)

(73) Assignee: Telefonaktiebolaget LM Ericsson (publ), Stockholm (SE)

(21) Appl. No.: 17/052,967

(22) PCT Filed: May 3, 2019
(86) PCT No.: PCT/EP2019/061398

§ 371 Date: Nov. 4, 2020

Related U.S. Application Data
(60) Provisional application No. 62/667,429, filed on May 5, 2018.

(51) Int. Cl. H04L 29/06; H04L 9/06; H04L 9/32; G06F 16/9035

(52) U.S. Cl. CPC H04L 63/0876; H04L 63/0823; H04L 2209/38; H04L 9/3213; G06F 16/9035; H04L 9/0643

(57) ABSTRACT

Method for managing access to one or more resources are suggested, where the managing is applied by using a blockchain. The method comprise: Sending, from a service provider to a data-base, a first identity contract, wherein the first identity contract comprises one or more of an identity of a service provider and a credential reference of the service provider; establishing a service relationship with a service user of the service provider; and sending, from the service provider to the database, a service contract based on the service relationship, wherein the service contract comprises one or more of identification information regarding the service provider and the service user, and access information for the service provider and the service user, wherein the database contains a second identity contract with respect to the service user, and wherein the database has an exposure contract with respect to the one or more resources, and wherein the database is configured to authenticate and authorize the service contract based at least in part on the first and second identity contracts and the access information.

### TECHNICAL FIELD

Disclosed are embodiments related to authentication and access control by service users and/or providers, and particularly, use of a blockchain for managing such authentication and access.

### BACKGROUND

In many applications, a blockchain can be viewed as a ledger or distributed database that maintains a continuously growing list of data records and programs, which typically describes all transactions that have occurred, or at least that have been incorporated into a main branch of transactions.

A main objective of many blockchain applications is to prevent the database from being tampered with and revised, even if many (but not a majority) of operators collude. The initial and most widely known application of blockchain technology is the public ledger of transactions for Bitcoin. Another public blockchain is Ethereum, and there are also closed group (or permissioned) blockchains like Hyperledger fabric. Permission blockchains can operate much faster than pubic blockchains that span multiple contents. A permission blockchain is built and expanded, for example, by having a set of operators or miners cooperating under a consensus rule that guarantees that only collectively agreed items are added.

Specifically, the blockchain is built from a chain of hash values, also denoted hashes, which are the outputs returned by a hash function. That is, each block of the blockchain contains a hash of the previous, i.e. preceding, block. This has the effect of creating a chain of blocks from the very first block (often termed the genesis) to the current block being incorporated. The chronological order of blocks is guaranteed because the previous block's hash would otherwise not be known. The idea is that it should be computationally infeasible to modify a block once it has been incorporated into the ledger, to do so means regenerating every block after the effected block. No single authority or miner should have sufficient computing power to perform such a computation faster than the blockchain infrastructure. Being able to do so would mean being able to, for the Bitcoin example, perform double spending of coins or modify recorded transactions.

An important feature of blockchains is that the transactions are handled by letting them be input to so-called smart contracts that are stored in the blockchain. The smart contracts constitute of code and possibly state variables and the blockchain operators can execute this code, update the state variables, and, possibly create events. A typical event can be a transaction that triggers the execution of other smart contracts. Thus, transactions can cause a chain of smart contracts to be executed. Another type of event in a permissioned blockchain can be that the blockchain operators that build the blockchain interact with the submitters.

Presently, various access control models exist, such as role-based access control (RBAC), target-based access control (TBAC), and attribute-based access control (ABAC) that can be realized using various frameworks, such as OAuth2, OpenID Connect, LDAP authorization, RADIUS, etc. For instance, telecom nodes generally employ RBAC with authorization requests sent to a central authorization server, such as LDAP or RADIUS. The authorization servers are managed by a telecom operator and include pre-defined roles with specific sets of privileges to which a subject is associated.

The above setups work in cases where the trust relations that determine how to configure the authentication and authorization can be easily handled centrally. However, in dynamic Service Based Architectures (SBA) like those being adapted by the 3GPP standardization, for use in mobile networks, this approach scales poorly. Also, the classical approach of using contractual paper Service Level Agreements (SLAs) is not adopted in an environment where services dynamically have to be created and torn down. The shortcomings are particularly troublesome for the Radio Access Network with its high demand on performance.

Additionally, and as illustrated with respect to FIG. 1, the exposure of resources, e.g. data and services, is in principle recursive. For instance, through a first exposure of a service one often creates a new service to which a service user in turn can be exposed, such that there may be a second exposure, albeit under terms of conditions, which may also be affected by the conditions that follow from the first exposure. Hence the service user of a first exposure becomes a service provider for the second exposure. For example, as shown in FIG. 1, a data owner 1 may expose its data to service providers 1 and 2. These service providers may then allow a second exposure, for instance to service users 1, 2, and 4 3. In some instances, the data may be combined with that of a second data owner 2. Additionally, a service user 3 may be a service provider 3, for instance, based on the data from data owner 1 via service provider 1. FIG. 4 provides examples of functionality that may be exposed.

A public blockchain Ethereum is used in “Smart Contract-Based Access Control for the Internet of Things,” Yuanyu Zhang, Shoji Kasahara, Yulong Shen, Xiaohong Jiang, and Jianxiong Wan, 2018, available at https://arxiv.org/pdf/1802.04410.pdf. However, this approach has several drawbacks, and in particular, drawbacks for industrial use. One drawback is that all updates to the ledger will consume so-called gas which relates to the built-in currency in Ethereum. This will be so for any public blockchain, as these must have a built-in reward system. Furthermore, the cost of such transactions is not predictable as the public blockchains lack, per construction, a coordinated governance structure. Furthermore in the paper, the authorization control is entirely based within blockchains, but blockchains are slow which, again makes such use of blockchain in such a fashion limited in its practical usefulness. All these shortcomings make clear that any existing use of blockchains scales badly, and would be prohibitive, even if one replaced the public blockchain by a permissioned chain.

Accordingly, there remains a need for improved access control.

### SUMMARY

According to some embodiments, methods and systems for managing access to one or more resources are provided. This may include, for instance, access to service resources, such as reading data present in a network node.

The diversity of 5G Radio Access Network (RAN) service requirements, and the modern way to implement services from microservices, can complicate the security configuration and management. Therefore, a RAN cannot continue to rely on manual configuration, management, and responses, since it would decrease the efficiency and increase costs of operations. 5G RAN capabilities should be managed automatically, including the deployment, scheduling, configuration, and invocation of network services and functions.

A new access control mechanism is required that enables 5G network resource owners (e.g. telecom operators, verticals) to provide different actors/subjects with access to objects of various ownership and state, such as internal network information, configuration & control services, and possibly simultaneously hence introducing the problem of potential race condition and double-spending.

Existing RAN authorization frameworks are typically managed by a single entity (mobile operator) and do not inherently offer resilience to attacks by a malicious adversary. 5G network use cases imply a complex and diverse resource ownership model where often the number of objects cannot be controlled by a single entity, and the security policies cannot be set based on simple rules, e.g. as facilitated through a role-based access model. An adaptable policy-driven access control model, such as an attribute-based access control model, may be required to address the challenges of 5G network; at the same time, the highly dynamic nature of 5G network requires the appropriate technology that would be able to enable high level of automation for defining the security policies, and at the same time would be able to offer assurances to all parties e.g. through the transparency of actions.

The existing solutions at the heart of authorization capability, such as OAuth 2.0 [RFC 6749], address the three-party access control by introducing an independent authorization layer. However, OAuth 2.0 relies on the presence of an authorization server that must be under exclusive control of a single, not necessarily trusted by all participants, entity. Also, the resource servers are assumed to define and implement their own independent security policies and take care of their own accounting and logs, which reduces the transparency and hence mutual trust, and, probably, would require introduction of an independent, trusted party (e.g. clearing house).

Federated identity management based on a public key infrastructure (PKI) adds another dimension of complexity when it comes to the handling of multiple relations between certificate authorities. These relations must be pre-defined in advance and kept unchanged. Another similar solution for addressing the access control to various resources by multiple subjects is cloud access security broker (CASB). However, the existing CASB implementation assumes that CASB has a single owner who is responsible for defining security policies, their implementation and enforcement, as well as keeping track of logs and accounting.

A particular problem arises when the question of access implies not only “whether” to grant access, but also “when.” For instance, not only getting an API to fetch information, but when to access, implying the use of an API through which a service user can make modifications. When such access is provided, the current solutions are too coarse in controlling what modifications can be allowed. Moreover, the mechanism used to define policies for what modifications a specific user can make, and their relation to the resources available at a specific time, are at best a list of permissions and conditions that are insufficient.

Furthermore, transactions within these frameworks generate log events that are either stored locally in files on an authorization service/server or sent to a centralized logging server. These mechanisms suffer from additional security challenges. For instance, traditional logging mechanisms, such as system logs and syslog, do not provide by default mechanisms protecting the integrity of logs. This introduces threats, such as log erasure, log modification, and data loss, which may result from any number of sources, such as system error, administrative error, or targeted attack. Additional controls can be implemented using software solutions such as remote backup, data protection solutions, etc. However, these require additional investment and if managed or configured incorrectly may not provide the necessary level of assurance.

In sum, none of the existing access control and trace solutions fully address problems with multi-party trust and high granularity of controlled objects with complex model of ownership that are crucial to anticipated 5G network use cases.

Embodiments leverage the use of redundancy, integrity protection, auditability, fault tolerance, and execution of smart contracts in blockchain to provided telecom services to multiple actors concurrently. This can allow resource owners, such as telecom operators, and/or service providers to define customized services to actors based on a set of access control policies on various attributes such as user attributes, resource attributes, and service attributes. In certain aspects, the efficient creation of auditable charging records, service usage transactions, and immutable access control are created.

According to some embodiments, to achieve and capture the trust relations between the different entities involved an overall blockchain is used that is trusted as notary-public where agreements are securely recorded so all entities can check the validness of an agreement. The agreements are, for instance, smart contracts or extensions of existing contracts. To guarantee confidentiality by avoiding an unwanted disclosure, the actual agreements may not be recorded in the blockchain, but rather, are only made available via database or permissioned blockchains to those that need to read and have permission to do so and have only trust anchors (i.e. hashes of the agreements together with administrative information) to be recorded in the overall blockchain. Furthermore, to achieve efficiency for the access control and log recording, a secure agreement caching is introduced and high-speed blockchain log fingerprinting is used. This allows not only fast access decisions, but also fast log protection as dictated by agreements.

According to some embodiments, a method for authentication and access control for one or more resources is provided. The method may comprise sending, from a service provider to a database, a first identity contract, wherein the first identity contract comprises one or more of an identity of the service provider and a credential reference of the service provider. The credential reference, in some embodiments, is a public key or hash of a secret key. The method may also comprise establishing a service relationship with a service user of the service provider, and sending, from the service provider to the database, a service contract based on the service relationship, wherein the service contract comprises one or more of identification information regarding the service provider and the service user, and access information for the service provider and the service user. The method may also comprise establishing the exposure contract. In certain aspects, the database contains a second identity contract with respect to the service user, has an exposure contract with respect to the one or more resources, and is configured to authenticate and authorize the service contract based at least in part on the first and second identity contracts and the access information. Authentication and authorization, for instance of the service contract, may be performed using an outside service. The one or more resources may comprise, for example, data, services configurations, and/or control APIs accessible to the service provider and/or service user. The database may be a distributed database comprising a blockchain, such as a permissioned blockchain.

In some embodiments, the one or more resources belong to a data owner, the data owner is separate from service provider, the database has an identity contract of the data owner, and the exposure contract for the one or more resources is with respect to the data owner.

According to some embodiments, the method may further comprise: receiving, by the service provider from the service user, an invocation of service request for at least one of the resources; and authenticating the service user with the database or an outside authentication and authorization service, wherein the authenticating is based on one or more of an identity of the service user and the service contract. This may also include initiating a service request, wherein the database is configured to perform the following based on the service request: authenticate the identity of the service provider, authorize the service provider for the requested service, execute the service contract, execute the exposure contract, and register the request. In some embodiments, registering comprises logging one or more of the time, exit criteria, and a hash of an access token.

In some embodiments, the service provider receives from the database a response to the service request. The response may include, for example, one or more an access token for the resource, requested data, the result of an action, log information, and charging instructions. In some instances, the response comprises a notification of denial.

According to some embodiments, the service provided may have the resource. In such cases, the method may further comprise: sending, from the service provider to the service user, the resource; and registering the sending with the database. Alternatively, it may comprise sending, from the service provider to the service user, an access token for the resource; receiving, at the service provider from the service user, the token at a later time; validating the access token; sending, from the service provider to the service user, the resource; and registering the sending with the database.

According to some embodiments, the service provider does not have the resource. In such cases, the method may further comprise: sending a first fetching request for the resource to the data owner, wherein the data owner is configured to validate the first fetching request with the database; receiving the resource from the data owner; sending, from the service provider to the service user, the resource; and registering the sending with the database. In some embodiments, before sending the first fetching request to the data owner, the method may include receiving, at the service provider from the service user, a second fetching request for the resource; validating the second fetching request; and unpacking the second fetching request to generate the first fetching request.

In embodiments where the service provider does not have the resource, the method may comprise, for example: sending, from the service provider to the service user, an access token. In certain aspects, access token can be configured to cause the data owner to perform the following upon receipt of the access token from the service user: validate the access token, send the resource to the service user, and register the sending in the database.

According to some embodiments, the invocation of request for the resource is a request to modify, create, or delete the resource. For instance, a service contract may allow the service user to create, modify, or remove a transport service between two User Network Interfaces (UNI) in a transport network. The contract may allow a service user to perform a simple service, perform a complex service, create data, and/or modify data. The contract may allow the service user to implement a service change applicable to an underlying physical network. The contract may allow the service user to adjust one or more bandwidth parameters. According to some embodiments, modification of a resource may include the insertion or deletion of code. In some embodiments, the service contract is, at least in part, a license contract and the response comprises an access token granting a temporal license. For instance, a data owner may grant a license to a service provider with respect to the resource(s) with sub-licensing rights, and the service contract may grant the service user license rights. Such rights may be for a limited time, for example, using the access token and validation processes described herein.

In some embodiments, the database is configured to perform the following based upon the receipt of a service initiation request from the service provider to enable the modification, creation, or deletion by the service user: verify that the service provider and the service user are associated with the contract, verify that the request complies with one or more static rules and policies, and verify that the request complies with one or more dynamic data conditions and policies. The data base may also verify, with an external system, that the requested modification, creation, or deletion with respect to the resource can be provided.

In some embodiments, data is exposed as a smart contract.

In some embodiments, a resource comprises one or more of network information, configuration, control services, and networking and computing resources.

In some embodiments, a computer program product comprising a non-transitory computer readable medium storing computer instruction which, when executed by one or more processors of a node, cause the node to perform the methods described herein.

In some embodiments, a service provider node is disclosed. It may comprise, for instance, a memory and processing circuitry coupled to the memory, wherein the service provider node is configured to perform the steps of the methods described herein.

In some embodiments, a telecommunications system is disclosed. It may comprise, for instance, a service user; a blockchain database; and a service provider. The service provider can be configured to perform the processes described herein. In some cases, the system may further include a data owner, separate from the service provider.

According to some embodiments, the execution of a particular process or step is described. This may include, according to some embodiments, initiating such a process or step. Such a process or step may be executed in a particular node, for instance, or the node may initiate the execution of that step in another node or network element, such as a cloud element. In certain aspects, some steps may be executed in a distributed fashion, meaning that one or more steps may only be initiated locally, while the actual execution is performed elsewhere, such as, e.g., in the cloud.

The advantages of disclosed embodiments are numerous, as set forth above. For example, some embodiments consolidate what would traditionally require several solutions into one elegant solution. This apparent, for instance, when considering the case where authentication, authorization, access control management, and logging are all put under a central control of the programmable logic of the blockchain.

Additionally, through the use of smart contracts and according to some embodiments, it is possible to expose RAN functionality that realizes great flexibility in how users can do modifications to granular resources, or otherwise consume data services, and at the same time can do so while adhering to security, operational, and business conditions that service providers want to have in place before they or the resource owners dare to expose their resources.

Additionally, embodiments support multi stakeholders for owners of the resources, and service providers, and allow a recursive nature that allows service providers to become resource providers for other service providers. This may be illustrated, for instance, with respect to FIG. 1.

Furthermore, according to some embodiments, systems and methods that give mutual assurances to all involved parties, including contractual obligations to those that provide services described in service contracts, are disclosed. Such systems and methods give the ability to fairly charge according to terms of use capture in smart contracts, reduce fraud or manipulation of charging and transaction records, and provide built-in resilience for protecting against data loss while ensuring high availability.

These and other embodiments are further described herein.

### BRIEF DESCRIPTION OF THE DRAWINGS

The accompanying drawings, which are incorporated herein and form part of the specification, illustrate various embodiments.

FIG. 1 illustrates aspects of data exposure in a multi-party environment comprising service users, service providers, and data owners.

FIGS. 2A-C are flow charts illustrating a process according to some embodiments.

FIGS. 3A-C are flow charts illustrating a process according to some embodiments.

FIG. 4 illustrates resource exposure, including information, configuration, and control data.

FIG. 5 is a flow chart illustrating a process according to some embodiments.

FIG. 6 is a network diagram according to some embodiments.

FIG. 7 is a block diagram of a node according to some embodiments.

### DETAILED DESCRIPTION

In some embodiments, a database is used. It may be, for example, a distributed database and may comprise a blockchain. The blockchain may be, for instance, a permissioned blockchain that has a ledger in which any participant can read data in the ledger. However, in certain aspects, certain data in the ledger may be sealed (e.g. encrypted) to a participant that is the owner of the data.

According to embodiments, there may be different entities (and roles) that are used for describing interactions, and in particular, the interactions with a blockchain. For instance, there may be entities that manage a permissioned blockchain, data owners, service providers, and services users. Specific examples include:
managers of the blockchain, which may read/write service contracts and entries, etc.;
service providers (SPs), which may read/write service contracts and entries related to their service users, relationships with services providers, and data owners;
data owners (DOs), which may read certain contracts and transaction entries associated with their resources, and may need to write permissions to optionally express smart contracts that describe policies that are generally to be applied to all their exposure contracts in order to optimize (e.g., reduce) the size of exposure contracts; and
service users (SUs), which may have read permission for their contracts, transactions, and charging entries.

Thus, in some embodiments, certain participants have the permission to submit transactions that, as a result of the execution of one or several smart contracts, can modify the data and will add entries to the ledger. Permissions are assigned on the basis of registered identities, which are special contracts used for identifying those that interact with the blockchain and on the basis of additional contracts that govern the access to objects in the blockchain, such as data and execution of other contracts. Contracts can also specify access conditions (or authorization), to resources outside the blockchain. In such cases, these permissions may be viewed as grants (as per an agreed contract) that an external entity, e.g., a resource owner, can use as authorization instructions for the resources.

In some embodiments, a resource can be an API to read data or an API to modify objects or functions in a node or even an API to a complex service.

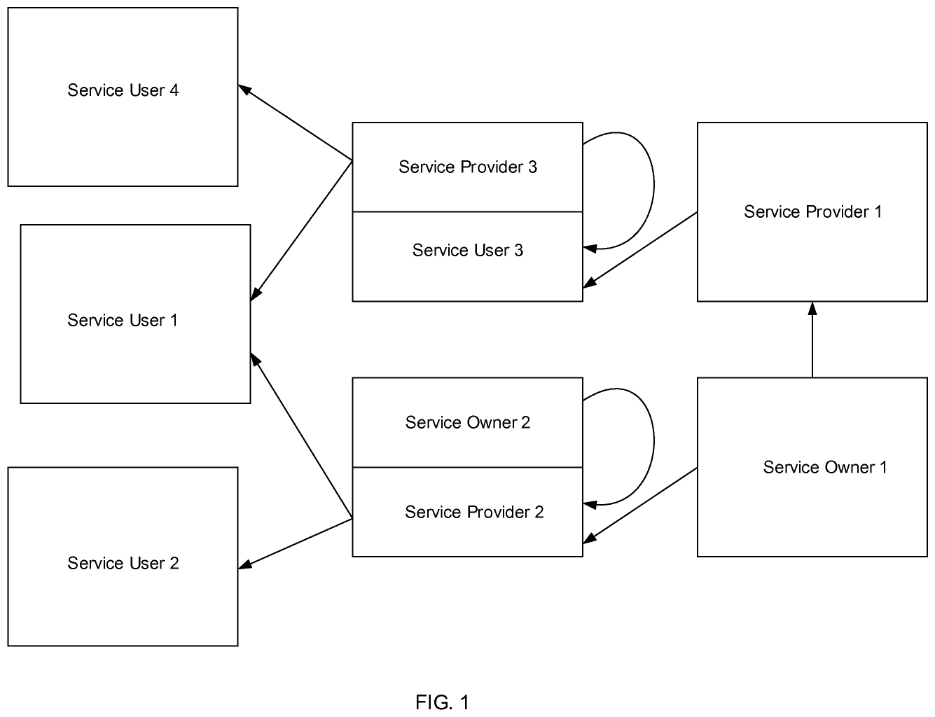

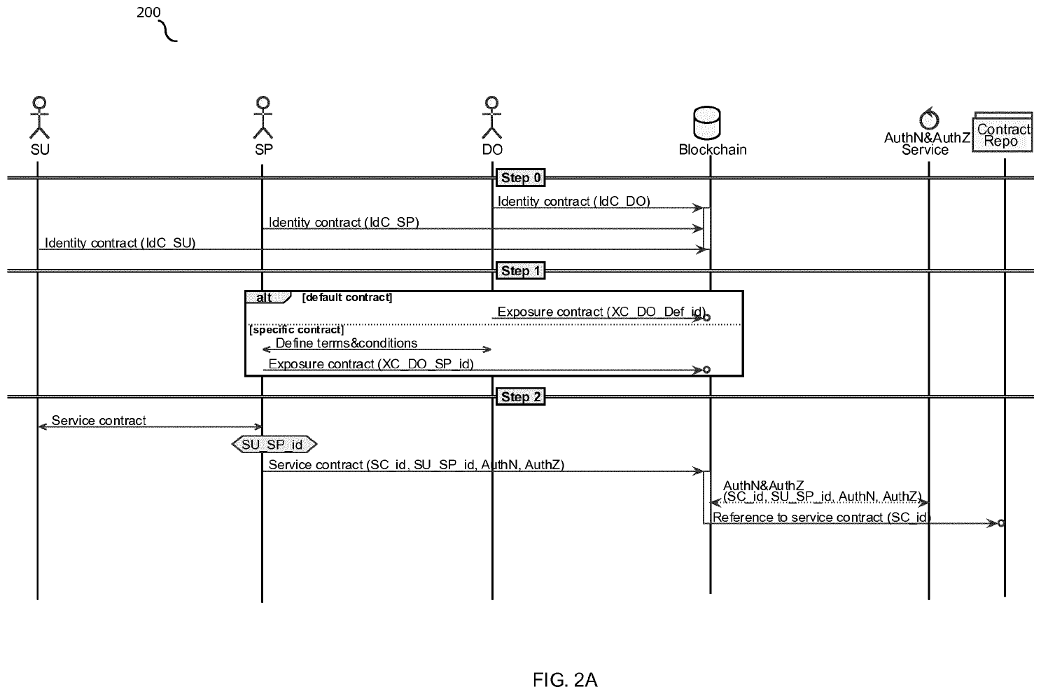

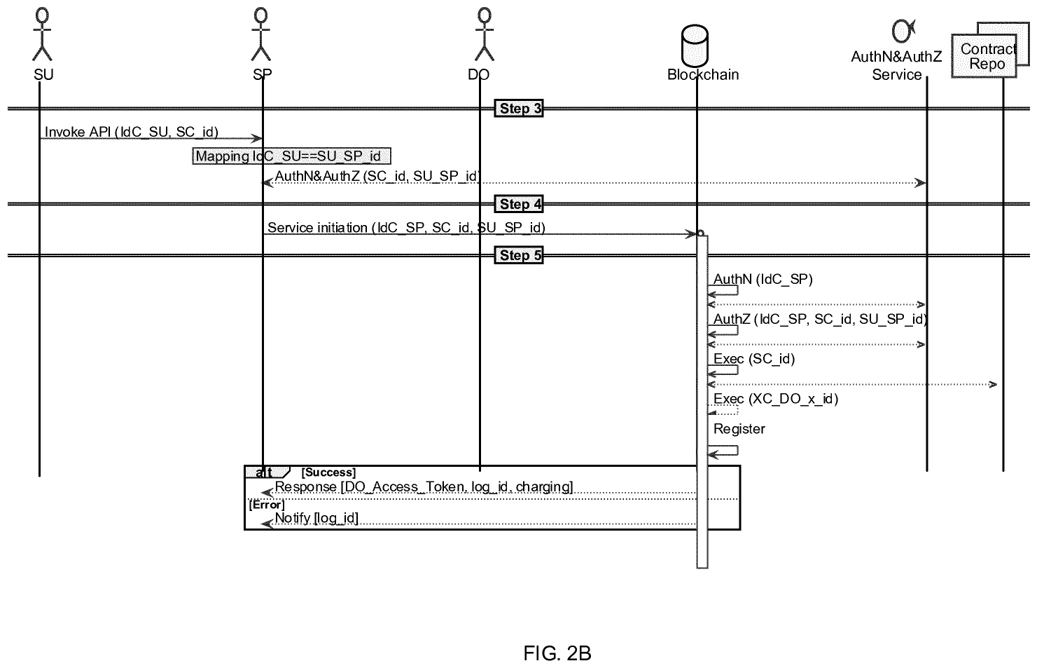

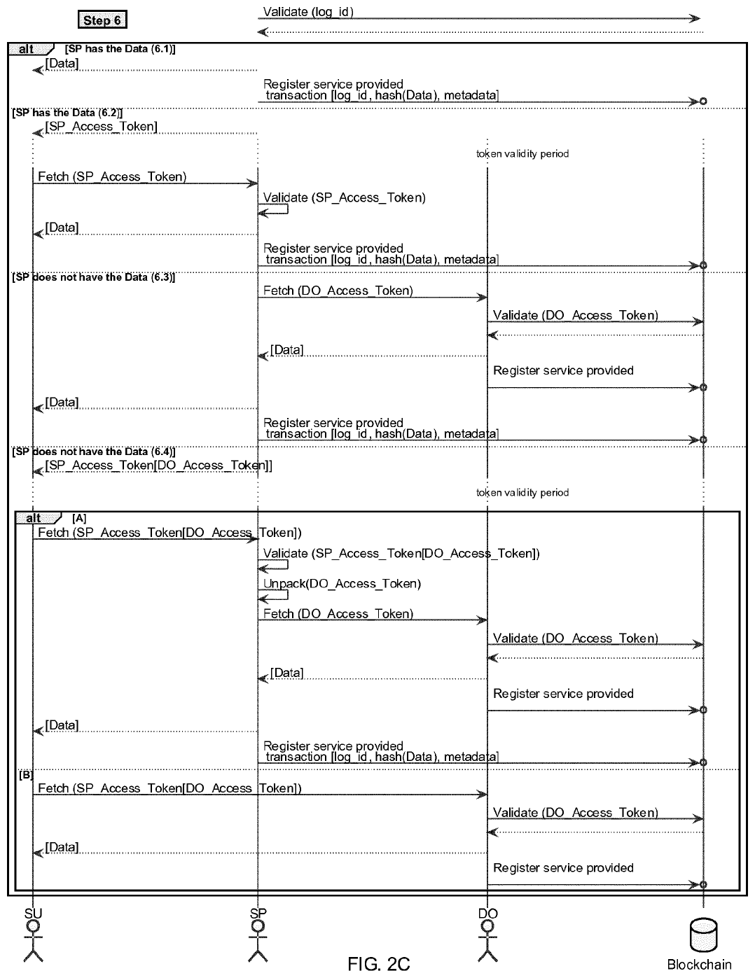

Referring now to FIGS. 2A-C, according to an embodiment, a process 200 is described for the efficient exposure to read access data in node resources. Process 200 may apply, for instance, to a node N in which data resides that is of interest to a set of Service Users (SU)s. The owner of N wants to expose a resource in N via an API as a service. In this example, the owner of N owns the resource and is referred to as the Data Owner (DO) and the actor that is the owner of the service is referred to as the Service Provider (SP). The SP can expose data under the conditions set by the DO(s). While FIGS. 2A-C depict the SP and the DO as two different actors, according to embodiments, they may be a single actor. That is, the service provider may be the data owner. Additionally, while FIGS. 2A-C only illustrate the presence of one DO, more than one DO may be present, for instance as illustrated with respect to FIG. 1.

The various steps illustrated in FIGS. 2A-C are described below.

[Step 0] According to some embodiments, the database, such as a blockchain, must keep track of the actors that interact with it, for example, to associate an incoming transaction with a given actor. Towards this end, the blockchain has registered so-called identity contracts for those actors that will interact with the blockchain. For example, an id-contract (IdC) can include a credential reference of the actor, organization name, legal name, roles, privileges and other relevant information. Here a credential reference may be data linking a secret that the actor uses as proof of its identity and such credential reference can, for example, be a public key or a cryptographic fingerprint, like SHA256, of a secret key. Responses from the blockchain can be verified to originate from the blockchain via the ledger using recorded hash of the response. The blockchain can encrypt data to the public key of an actor that is registered as part of the identity contract. In certain aspects, the identity contracts may be code/scripts or smart contracts. This logic may be used to reach back and verify a particular entity. In some embodiments, it may provide reporting functionality.

[Step 1] To arrange for a controlled exposure of one or more resources, the SP and the DO establish contracts. Towards this end, the DO attaches a so-called smart (exposure) contract to one or more resources. According to some embodiments, the DO may attach different exposure contracts to its resource. There could be, for instance, a default contract as well as specific contracts for each of the SPs. The contracts, or alternatively secure references to the contracts, are stored in a blockchain in this example. Storing contracts in the blockchain can refer to both direct storage and storage of references.

In embodiments where the SP and DO are the same, step 1 may just comprise storing the exposure contract in the block chain.

According to some embodiments, step 1 may comprise authentication and/or authorization in the blockchain before storing the exposure contract. This may be based on, for example, the content of previously-stored identity contracts from the DO and/or SP.

In some embodiments, the DO defines the terms and conditions in the contract. However, this may be facilitated by the SP since it is the SP that will publish the contract on behalf of the DO. In certain aspects, the DO can at any point verify the content of the contract. Additionally, the DO(s) may publish contracts in the blockchain themselves. These contracts can be defined such that any SP could invoke the contract to consume the service associated with it. This creates a market place where a DO can publish their data and services and where SPs can search for and utilize these contracts as necessary. Accordingly, there may be different types or classes of contracts. For instance, those that are bound to a specific entity (e.g. SP or SU) and those that are open and can be consumed by any entity recognized in the blockchain, given proper protections as set forth herein.

[Step 2] An SU may want to use a service or otherwise access a resource. In this step, and according to some embodiments, an SU that wants to use a service or access a resource will negotiate a smart contract with a SP. This contract can be referred to as the service contract, and may be stored on the blockchain. The service contract can include, for example, the agreement on authentication information, an authorization profile and policies that govern the rules for using the service to access data. For instance, a service contract may define whether authentication and authorization are completed in the blockchain or by an additional authentication and authorization service (“AuthN&AuthZ Service”). While in some embodiments a contract may be stored in its entirety, a reference to the contract may be stored in the blockchain. In some embodiments, contracts may be stored in a contract repository (“Contract Repo”).

The service contract also allows the SP to invoke a transaction on behalf of the SU. The SP records for the SU include information, such as a service contract identifier (SC_id), the service user identifier (SU SP_id), and authentication/authorization information (AuthN/AuthZ). According to some embodiments, the SU has an identity that is associated with or provided by the SP. A SU may have different identities, each associated/provided by a different SP. That is, there is ability to use a common SU identity for several SPs according to some embodiments. With the service contract, both parties (the SU and the SP), and indeed all other actors associated with the blockchain according to some embodiments, can examine the contract. This may include, for instance, verifying that the right profile and policies are used when the service is invoked. Because the service contract is identified through a contract id, a secure reference to a contract can be realized by storing the contract id, e.g. a hash or digital signature of the contract, and possibly the identifier of the owner of the contract.

According to some embodiments, the authentication information in the service contract is data that allows the blockchain to authenticate SU when the SU submits an access request. The authorization profile and policies to expose data to the SU may be recorded in the service contract. In some embodiments, in order to get access to the resource, it may be required that not only the conditions for the service contract are met, but also the conditions of the data exposure contract. The latter may be particularly important if the SP is not also the DO.

According to some embodiments, the exposure and service contracts can be stored on the blockchain. Alternatively, they can be stored in a contract repository (that the SP and DO agree upon for storing data exposure contracts), in which case the blockchain has a cryptographic fingerprint (e.g. a SHA256 hash) of the contract, and a locator (e.g. URL) to the contract repository so it can fetch the contract if needed. Such a contract repository can be more efficient than storing all contracts directly in the blockchain and can mitigate the risk of exposing private (wrt to SP, SU, or DO) information in the contract. The use of distributed contract stores makes it also easy to load-balance demands. In practice the contract repository can be a redundant system to prevent the repository from becoming a single point of failure.

According to some embodiment, and in variations of step 2, the authentication information for the SU is a URI to an agreed authentication service that is to be invoked when authentication is required, i.e., when the SU actually requests access to the data.

[Step 3] Referring now to further steps of the method mentioned above, which are depicted in FIG. 2B, according to some embodiments, to access where a service and/or one or more resources are accessed, an SU invokes the service API. The service API may be invoked using the SUs credential data, including SU SP_id and authentication material, that can be verified through the registered identity information in the service contract, and the contract ID that the SU wants to execute, and optional additional metadata that may be pertinent to the invocation and execution of the contract. In FIG. 2B, the authentication and authorization is illustrated using the additional service; however, according to some embodiments, it may be performed in the blockchain. This may be determined, for instance, based on one or more of the exposure and service contracts related to the service or resource.

[Step 4] In step 4, the SP starts processing the request, received in step 3. In some embodiments, the SP sends a service initiation message to the blockchain. This may include, for instance, sending the credential data, registered SU id and Contract id as a ‘service initiation’ transaction to the blockchain. This transaction may be signed using the identity the SP has registered in the blockchain.

According to some embodiments, the SP starts processing the request by locating the registered SU id and associated method to authenticate the SU. In this variant, the SP also locates the smart contract by a lookup of the smart contract in its repository, e.g. based on factors such as which service API was invoked, SU_ID, etc. Two examples are provided below:
https://serviceprovider.com/data/pm/12/abc123where/data/pm/12/indicates a specific service call and the SUID is abc123. This data can be mapped to contract id: AAD5F03.
https://serviceprovider.com/data/fm/456/abc123where/data/fm/456/indicates a specific service call and the SUID is abc123. This data can be mapped to contract id: C4EA9B0.

[Step 5] In step 5, according to some embodiments, the blockchain processes the service initiation, provided from the SP. This may include, for example:
(1) Authentication (AuthN) and Authorization (AuthZ). This may include, for example, sending information to a service, such as the idC_SP (for authentication) and the idC_SP, SC_id, and SU_SP_id (for authorization). The blockchain, upon receiving a service initiation transaction checks that the incoming transaction is coming from the claimed SP. Then it starts to check if the provided SU id_SP and contract information are valid by executing the service contract.
In the above, and according to embodiments, the SC_id is the reference identifier of the service contract. For example, according to embodiments, it is the agreed (in service contract) identifier for the SU towards the SP (the SU can have different identities (like pseudonyms)). In its simplest form, the SU_SP_id can be the idC_SU shown in the diagram at step 0 that is used when checking that a request is coming from a legitimate registered SU, and the idC_SP the identifier for the SP.
(2) Execution (Exec). This may include, for example, execution of the service contract and the exposure contract. According to some embodiments, the contracts may be executed in any order.
In some embodiments, the service contract is identified by the SC_id and the exposure contract is referenced through its identifier XC_DO_x_id. Both contracts are executed after authentication of the SP by using its identifier idC_SP and after the proper authorization has been established which involved the use of the identities of the involved parties and the information of the service contract referenced by its identifier SC_id.
(3) Registration (Register). This may include for example, logging. In some embodiments, the contract execution event triggers a log transaction that will ensure that a failed or successful attempt is securely registered in the blockchain. According to some embodiments, the log transaction contains data such as time, exit criteria, and hash of return token; the log transaction has a log_id.
According to some embodiments, the execution results in a decision that is imprinted in an access token and possible metadata, e.g. charging, time limits, etc. The log transaction can record this data for later verification. The access token value can be effectively fingerprinted by a hash to safe space in the transaction log. In certain aspects, the log_id is the identifier that can be used to locate the transaction log data.
(4) Response. This may include, for instance sending a response to the SP or notifying it of a failure, which can be logged. If the contract execution is successful, it may be necessary to execute also the exposure contract, for example, in a recursion scenario. If the blockchain contract checks result in a determination that access is allowed, then the SP receives a response that includes, for instance, an access token for the data, log information if agreed, charging instructions. Other metadata may follow in the response. In some embodiments, since the SP may act as a relay to deliver, part of, of the access token to the SU, the token fragments intended for the SU are encrypted to the SU's public key that was registered in step 0. If the contract execution ends with an error, then the SP is notified.

According to some embodiments, an access token may be a JSON Web Token (JWT); however, other enriched tokens may be used in some cases. In some embodiments, one or more access tokens may also comprise data. This data can be extracted, for instance, and the data then sent. In some cases, the entire token is not sent after extraction.

According to some embodiments, in a variant of step 5, as part of the execution the blockchain could, in principal, perform the authentication of the SU. However, it may be more advantages in some instances for the reliable working of the blockchain and for flexibility, that the blockchain only points at the authentication service to be used and the relevant metadata that has to be used for authenticating the SU. In this case, if the contract execution ends with an error, then the SP is notified. If the contract execution is successful the SP receives a response that includes an access token for the service, log information, if agreed, charging instructions and, in case the authentication is performed externally, the approved information that the SP can use to invoke an authentication service. Other metadata may follow in the response. The response may include, e.g., the requested data, the result of a running a command, or an access token.

[Step 6] Referring now to FIG. 2C, according to some embodiments, the SP then provides to the SU the requested service and/or resource, such as requested data. The steps shown in FIG. 2C may follow the steps of FIG. 2B. In some embodiments, the SP upon receiving a response, will verify the origin and content of the response in the block chain log using the log_id.

In some embodiments (6.1), the SP has the resource, such as data, already available and responds to SU with the requested resource. The SP may then register the transaction in the blockchain. In some instance (6.2), the SP will respond to the SU with an access token. In this case, the SU can fetch the data (or other resource) at a later time if so desired. When using a token, the SP may validate the token when received from the SU. This may be, for instance, to verify that it has not expired. Upon verification, the resource is provided. As in 6.1, the transaction is registered with the blockchain.

However, in some cases (6.3-6.4), the SP does not already have the requested resource, and must fetch it from the DO or other SP, and then respond to SU with the requested resource.

For example, if the SP does not have the resource, it may fetch a token from the DO. The DO may then validate the SP's access with the blockchain, for instance, using a DO_Access_Token identifier. If the time between creation and consumption of the token is small, there may be a need for executing the exposure and/or service contract in some embodiments. However, and in other embodiments, if the time is large, such execution might be necessary. If the token fetch is valid, the transaction is registered in the block chain and the resource, e.g., data, is provided to the SP. The SP may then in turn provide it to the SU, and register the transaction in the blockchain.

In some embodiments, the SP responds to the SU with a token, so that the SU can fetch the data later, using the token against the SP API and then the SP will collect the data from the DO. If the SP will respond to the SU with data, it will use the data it already has, or the SP will use the received token in a request to the DO to fetch the data. In the latter case, the DO will check if the provided token is valid, which can either be done via a signature that is in the token, or by consulting the blockchain log using the log id. The SP may, as a result of metadata that followed the response from the blockchain, create a ‘service provided’ transaction with the hash of the provided data and send this transaction to the blockchain.

If the SP responds to the SU with an SP access token that the SU can use to fetch data at a later time, there may be a given amount of time specified as a validity period in the token. According to some embodiments, the SP access token is a combination of the access token received from the blockchain and local SP data. The token received from the blockchain may contain fragments that are private to the SU, as explained earlier. For example, in case the SP wants additional protection of its service to be restricted to SU it can add to the SP service access token a MAC using a local (private to SP) key, e.g. by computing an HMAC, using SHA256.

In certain aspects, the SP access token can be used by the SU to get the data later from the SP, which first checks the token for its validness and can then respond with the data if it is already available, or it will pass the token (after unpacking it from the service access token) to the DO to obtain the data. In the latter case the DO checks the token in the blockchain log.

In some embodiments, the SP access token is arranged so that the SU can bypass the SP and fetch the data directly from the DO. Also, in this setup the DO checks the token in the blockchain log. In order to prevent misuse of the access token, the SU gets its token fragments encrypted to its public key

In some embodiments, and in a variant of step 6, external authentication is required, and the SP invokes the authentication service, using the approved information the blockchain has established by running the contract on the service initiation transaction input, in certain aspects, the invoked AUTH will perform an SU authentication and send the result back to the SP. The AUTH may optionally have contractual obligations to log the authentication event. The SP, upon receiving a successful authentication result, can proceed to handle the SU service request.

In some embodiments, the above authorization is done implicitly when the blockchain processes the ‘service initiation’ transaction. It may be advantageous, especially if authorization conditions are complex or their description in the smart contract may have privacy/confidentiality concerns, that the authorization is performed externally by a trusted service that was agreed when the contract between SU and SP was established. The blockchain ledger secures that the agreement on the trusted service is honored at the time of the actual authorization

According to some embodiments, some of the above steps can be done in a different order than as described. For example, authentication may be done first, followed by the authorization. Then, as an example, the blockchain first establishes the authentication information, sends this as a first response to the SP and also triggers a new transaction that establishes (by computing further using the smart contract) the authorization and sends that as a second response. In certain aspects, the SP will understand, from the first response, that it has to fetch a second response. This may be to avoid the SP acting as a server and having to listen to incoming messages that do not follow from a direct request.

Additional concerns may arise when an access implicates a modification of the resource through the provided API, such as writing or even larger modifications of resource, or a consumption of a service.

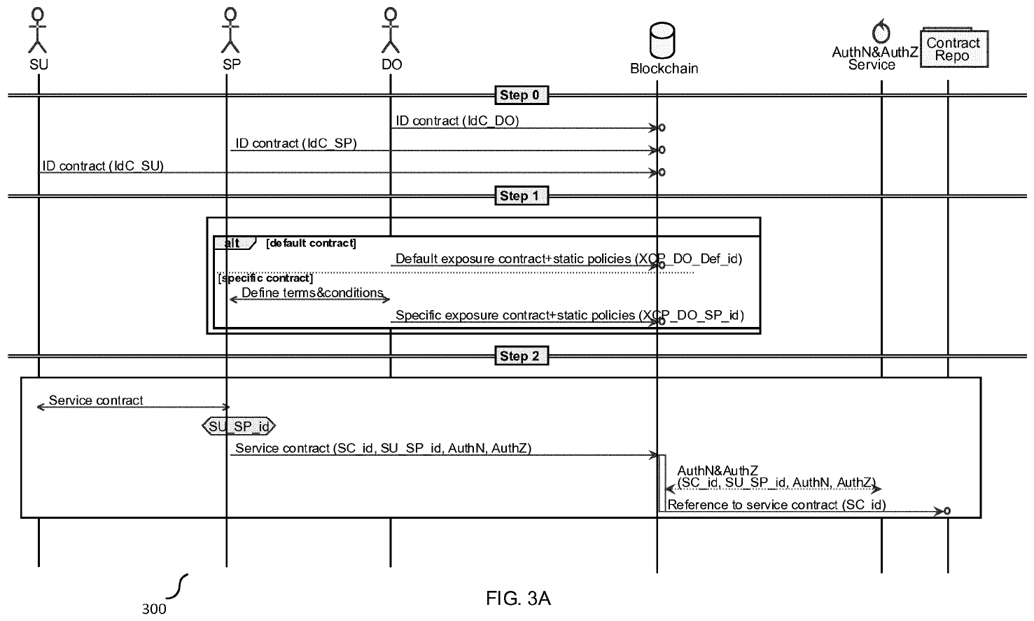

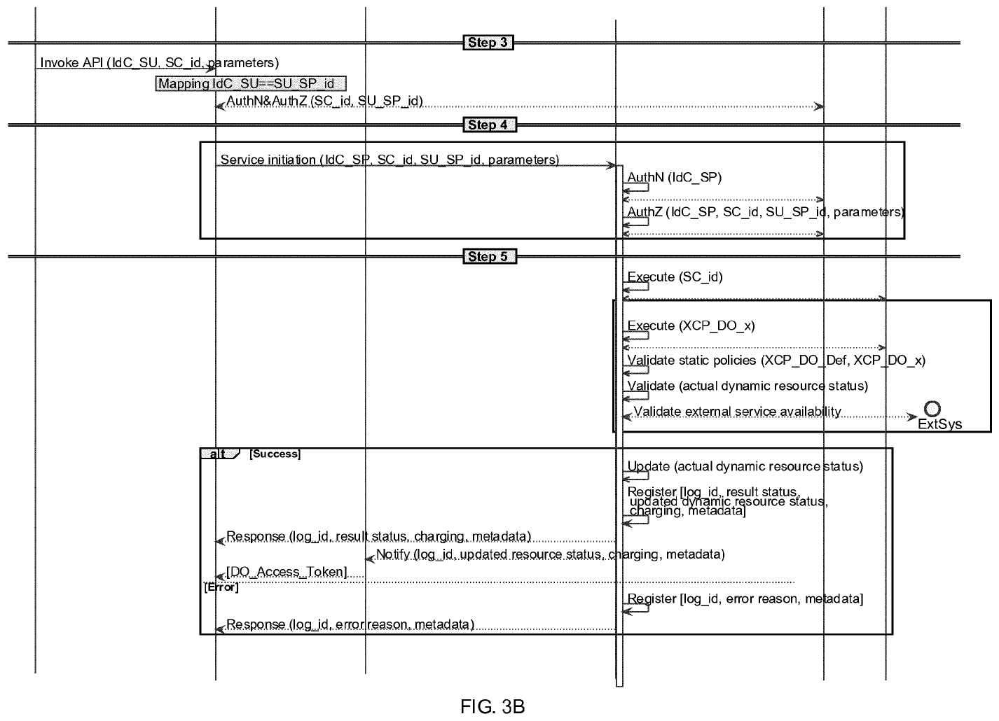

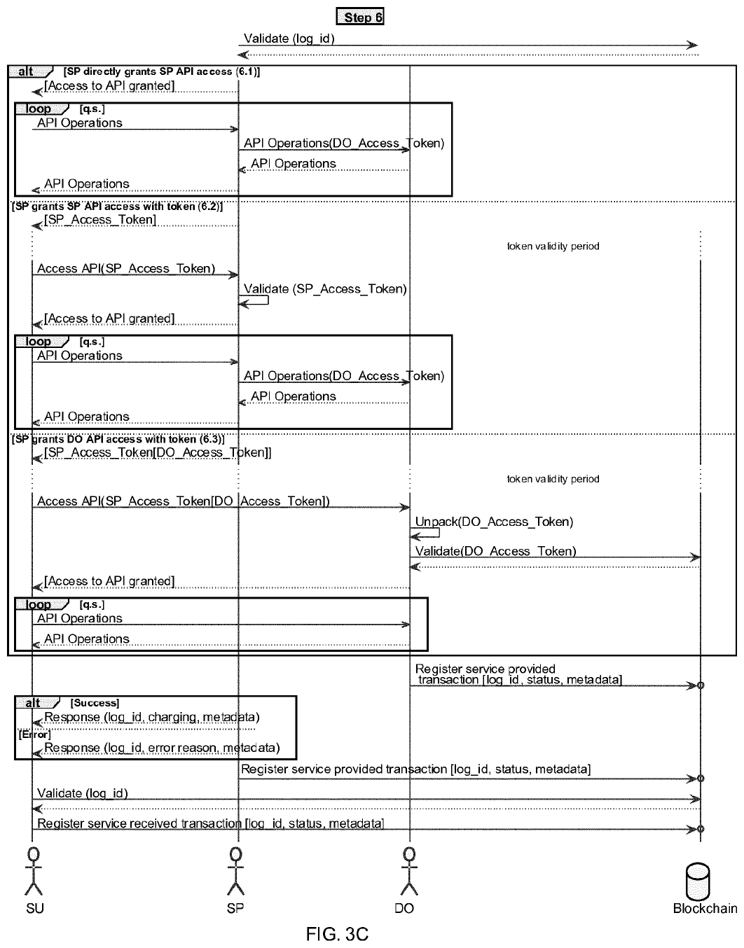

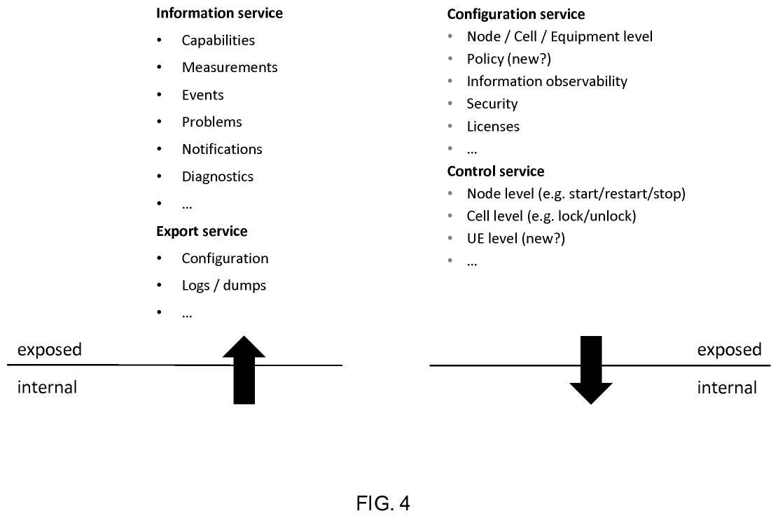

Referring now to FIGS. 3A-C, according to embodiments, a process 300 is described for the efficient exposure of read access and modifiable resources. In some embodiments, modifications may comprise writing of a variable. In some embodiments, they could comprise changing configurations, or even inserting code. Hence, such exposure can dramatically impact the exposed resource. In certain aspects, process 300 may apply to the situation where a service user will send data to the service provider that will affect the resource, e.g., by writing data to the resource or making changes to resource configurations.

According to some embodiments, [Step 0] of process 300, shown in FIG. 3A, may be substantially the same as Step 0 of process 200 in FIG. 2A.

[Step 1] According to some embodiments, a data owner DO may store a default exposure contract in the blockchain. This may, for instance, comprise one or more static policies relative to modification, creation, and/or deletion of a resource of the data owner. Additionally, and in some embodiments, the terms of the exposure contract may be negotiated with said service provider SP. Any additional specific requirements of the exposure contract may be stored in the blockchain as well.

[Steps 2-4] According to some embodiments, these steps of process 300 may be substantially the same as Steps 2-4 of process 200, as shown in FIG. 2A and 2b, respectively. However, and in certain aspects, the invocation may seek to modify, create, and/or delete a resource in process 300.

[Step 5] According to some embodiments, Step 5 of process 300, as shown in FIG. 3B, may share similarities with Step 5 of process 200, as shown in FIG. 2B. However, Step 5 of process 300 further includes, for instance: (i) validation with respect to both static and dynamic policies; and (ii) validation of a request with an external system. That is, according to some embodiments, the blockchain will verify the viability of the requested write operation before providing an affirmative response to the service provider. This additional check can protect against modifications that may disrupt other services, such as an upstream service.

[Step 6] According to some embodiments, and referring now to FIG. 3C, a service provider may directly grant a service user API access. This may result, for instance, in a loop of AIP operations between the service user and service provider, as well as between the service provider and data owner. In some embodiments, API access may be provided by the SP to the SU with an access token. In such embodiments, there may be a need for validation of the token when used at a later time. According to some embodiments, the data owner may grant API access to the service user. This may be based, for instance, on a token provided to the SU from the SP. In this case, API operations are between the SU and DO.

The foregoing processes of step 6 are not an exhaustive list. According to some embodiments, the steps of FIGS. 3B and 3C follow those of FIG. 3A.

According to some embodiments, there may be one or more nodes (N1, . . . , Ni) in which configuration data resides that is of interest to a set of Service Users (SUs) to modify. In this case, the owner of N1, . . . , Ni may want to expose a service whereby a SU may modify, create, and/or remove: (1) a specific set of configurations on a given node; and/or (2) a service or complex operation that modifies a set of configurations on a set of nodes N1, . . . , Nk, required to realize the service or complex operation. In certain aspects, the owner of N1, . . . , Ni owns the data and resources (e.g., network, spectrum, or compute) and can be referred to as a Data Owner (DO), and the actor that is the owner of the service referred to as a Service Provider (SP). In such embodiments, the SP can offer services to modify, create, and remove data and resources under the conditions set by the DO(s). As with other examples, the SP and the DO can be two different actors. For instance, a service contract can be agreed to between the SP and SU before it is published to the blockchain. The contract can capture the terms, conditions and definition of the service provided by the SP to SU that is exposed via an API.

According to some embodiments, the modification, creation, or deletion of data resources may be controlled by:
static policies and rules;
dynamic data, condition, and events within the blockchain, e.g., an API by a contract stored on the blockchain; and/or
decisions or constraints imposed by an external system, such as a resource controller or service orchestrator.

For example, in a case where the SP defines a contract with a SU to create, modify, or remove a transport service between two User Network Interfaces (UNI) in a transport network, the SU may call the service API to setup a service between UNI_A, and UNI _B with a set of service parameters, such as bandwidth and delay. Static policies and rules can control whether a service request is within pre-agreed limits of the contract. For instance, a service may not exceed 40 Mbps or request a service requires packet delay less than 2 ms. Dynamic data can be used to control decisions based on state information and terms in the contract. For instance, a SU may not have more than 10 active services at a given time. Since a SU can create and remove services over time, the decision whether a new service can be established is dependent on the current number of active/configured services. Additionally, the ability to deliver a service according to the defined service parameters may be dependent on the available resources in the network, which is impacted by other services that are configured or other network states, such as link availability. In some instances, ability varies due to load and other (e.g., internal) conditions on a node. According to some embodiments, one option is that relevant information is reported into the blockchain such that it can be queried and processed by a smart contract.

Another option is that a service contract interacts with an external system, such as a network management system, service orchestrator, or resource manager, for allocation, reservation, and confirmation of the ability to deliver a service. In some embodiments, this external system will be able to determine if a configuration change or service can be completed given the state and availability of network resources at the time of the request. If the service cannot be created according to the service request, the external system will sent a negative response to the service contract. The response may include an explanation to why the service could to be realized. The response may also include additional data to support further action by the SU, SP, or service contract.

According to some embodiments, a logical order of events from when the service contract is invoked may be as follows:
1. Verify that the SP and SUID are associated with the contract.
2. Verify that the service request complies with static rules and policies.
3. Verify that the service request complies with dynamic data conditions and policies
4. Verify that the service can be provided by an external system. In some instances, the external system may temporarily reserve resources to ensure they are still available when the service request is executed.
5. Return a response for the service request. In some cases, a positive response triggers the execution of the service request.
6. A successful execution of the service request may trigger a charging event. Service contract state information can be updated appropriately, and if the service cannot be fulfilled, then this will be reflected in the charging record.
7. A transaction event is logged (e.g., if this is not the same as the charging record).
8. The SP responds to the original service request.

According to one or more embodiments, there may be certain pre-conditions in place with respect to process 300. These may include, for example, that:
all actors have an account on the blockchain including an identifier and set of roles;
the DO and SP have established a set of contracts dictating the terms of use to modify, create, or remove data/resources on nodes N1, . . . , Ni;
the SU and SP have agreed upon and established a service contract that is published on the blockchain; and
the authentication and authorization of service invocation is similar to the previous steps 2, 3, and 4 of process 300.

In some embodiments, a service user may request access to a service where data is further exposed in a new smart contract. This case is similar to the one described with respect to process 300. However, and according to some embodiments, instead of the blockchain returning an access token, the blockchain creates a new smart contract which may be understood as a service exposure contract. Thus, during an execution that would have resulted in an access token according to other embodiments, the service exposure contract is computed. That is, whereas the token has captured a static access permission, the service exposure contract allows for dynamic tokens that describe an algorithm that, when executed, give access conditions. This allows for advance delegation of access. This may be particularly useful where a service user is allowed to modify over a given time period, as opposed to a single, isolated use.

According to some embodiments, the service exposure contract is the result of modifying template contracts into a final contract, using incoming transactions and the execution of a hierarchy of contracts, referred to as underlying contract(s), relationships and conditions. The service exposure contract can be stored in the blockchain or in a contract repository (in that case the blockchain only needs to store a fingerprint, e.g. a hash, of the contract to verify later that it uses the right contract when it needs to execute it) and the underlying contracts. The response that the SP receives may be the SC id of the resource contract. In some embodiments, it is also possible that the complete smart contract is given to the SP.

An SU can later invoke the service exposure contract that will then result in the exposure of the data. For example, the SU may pass the id of the exposure contract to the SP, which recognizes this as a service exposure contract and can pass this to blockchain, which will in turn obtain the contract itself, check its integrity, and then execute it. The execution, assuming a grant of exposure of the resource, will result in a response containing data or a permission to read or operate on the resources.

In cases where the SP is not the resource owner, and in some embodiments, the SU can directly send the service exposure contract to the resource owner. The service exposure contract, when it is executed to provide the service to SU, will assure that the SP can have visibility that the service has been provided to allow, for example, billing or logging the event for future audits. When compared to the approach where tokens were used and acted upon by given rules, the service exposure contract combines the notion of a token and the interpreting rules in one object, which may provide certain benefits. That is, it can provide a powerful, yet simple, method to control the exposure of resources.

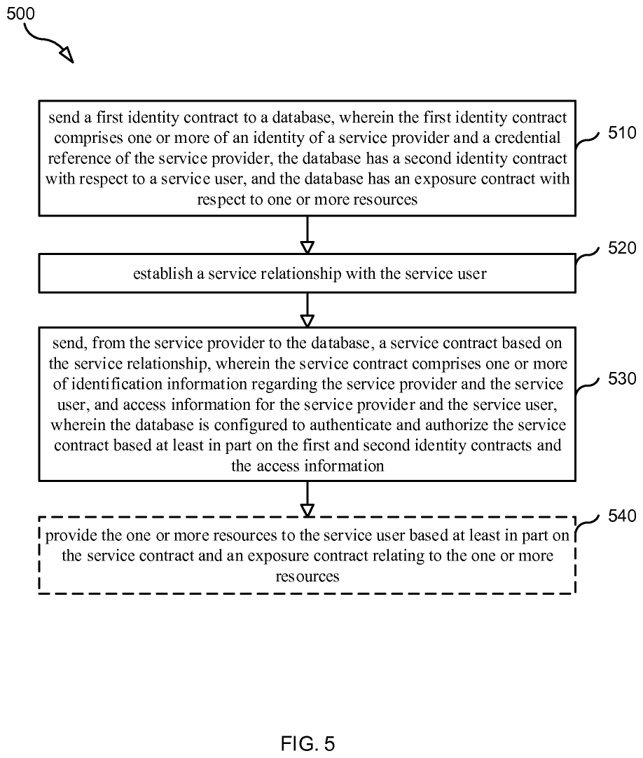

Referring now to FIG. 5, a flow chart is provided illustrating a process 500 according to some embodiments. Process 500 may be executed for instance, in one or more of the nodes illustrated with respect to FIGS. 2,3, 6, and 7, such as the service provider SP. In some embodiments, the database is a blockchain distributed database. In some embodiments, process 500 may be implemented in a distributed system, where steps are executed in one or more physical entities.

The process may begin, for instance, with step 510, in which a first identity contract is sent to a database from a service provider. In some embodiments, the first identity contract comprises one or more of an identity of the service provider and a credential reference of the service provider. Additionally, the database may have a second identity contract with respect to a service user, and the database may also have an exposure contract with respect to one or more resources. In step 520, a service relationship is established with the service user. In step 530, the service provider sends the database a service contract based on the service relationship. According to embodiments, the service contract comprises one or more of identification information regarding the service provider and the service user, and access information for the service provider and the service user, and the database is configured to authenticate and authorize the service contract based at least in part on the first and second identity contracts and the access information. Process 500 may also optionally include step 540 according to some embodiments. In this step, the service provider provides the one or more resources to the service user based at least in part on the service contract and an exposure contract relating to the one or more resources.

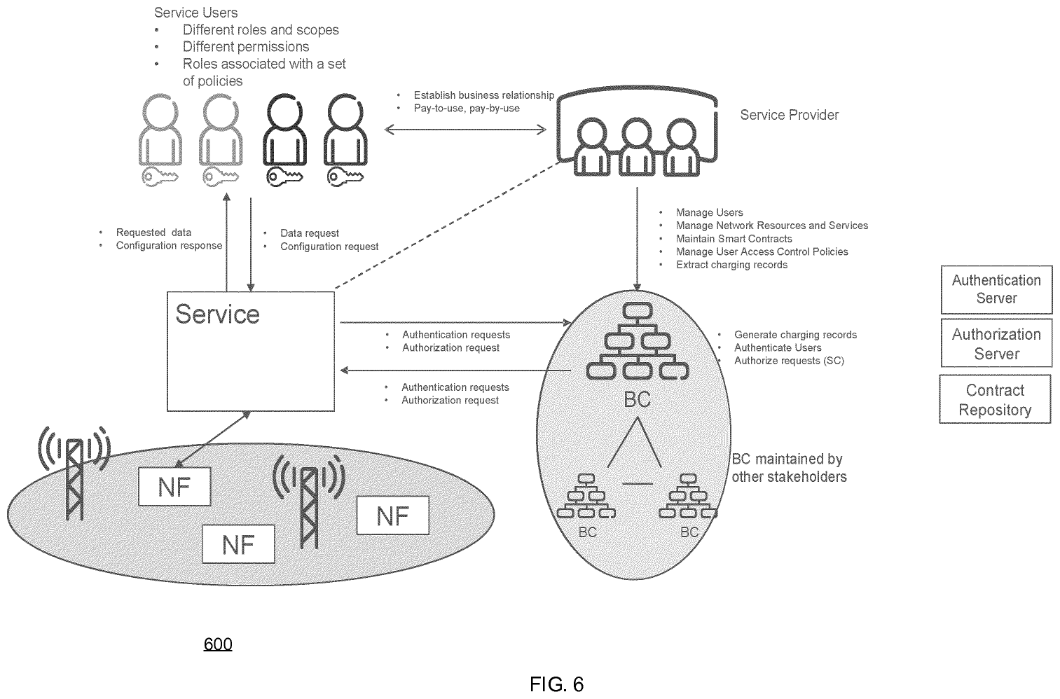

Referring now to FIG. 6, a diagram of network 600 is provided. The nodes of network 600 may be configured to perform one or more steps as set forth with respect to FIGS. 2, 3, and 5. The network may provide, for instance, a telecom service. In this example, the blockchain BC may be a permissioned blockchain. In this example, the blockchain may be used by the SC to specify authentication method for a given user entity or service. It can also be used to lookup a SC for a given user ID and service request, and in some cases, the SC includes logic to determine whether the user ID is authorized to access the service based on a set of conditions, e.g. request rate, volume, or available tokens. The block chain may also be used to register service requests. The authorization may be, for example, RBAC and ABAC authorization. The entities of network 600 can include, among others, the following:
Service provider—administrative domain owner, assigns roles and permissions. In some cases, that SP owns the NF/infrastructure.
Service users—have their customized services and conditions for use assigned by operator, may be an organization with internal organizational structure with different roles and responsibilities. These roles are mapped to the services provided by the operator. There may be an identity federation between the identity domain of the service users and operator, respectively. Alternatively, the service user uses identities provided by the operator.
Notary-public—manages the block chain—this role may be taken by the SP and/or service users.
Resource owner (API service resources).

Referring to FIG. 6, “NF” in 600 may refer to a Network Function. Additionally, and in some embodiments, the data owner may be hidden in the NF, or the data owner is the SP.

According to some embodiments, aspects of the disclosure may be implemented with respect to a social media service. For example, a service provider SP may be a social media provider, such as Facebook or Twitter. In this example, a data owner DO may be end users of the social media service, i.e., Facebook and Twitter customers. According to some embodiments, a third party may request access to the resources of the DOs, including for example, their content, information regarding their activity on the social media service, and or personal information. Such resources may be requested the third party service user as set forth in FIGS. 2-3 and 5. Similarly, access to and exposure of such resources may be controlled as disclosed herein.

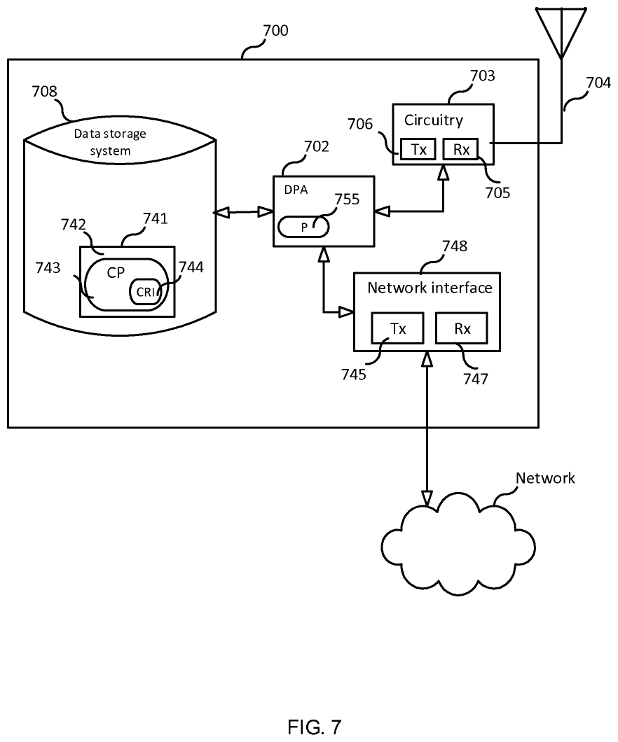

FIG. 7 is a block diagram of node, according to some embodiments for performing methods disclosed herein. As shown in FIG. 7, the node may comprise: processing circuitry (PC) 702, which may include one or more processors (P) 755 (e.g., a general purpose microprocessor and/or one or more other processors, such as an application specific integrated circuit (ASIC), field-programmable gate arrays (FPGAs), and the like); a network interface 748 comprising a transmitter (Tx) 745 and a receiver (Rx) 747 for enabling the node to transmit data to and receive data from other nodes connected to a network (e.g., an Internet Protocol (IP) network) to which network interface 748 is connected; circuitry 703 (e.g., radio transceiver circuitry comprising an Rx 705 and a Tx 706) coupled to an antenna system 704 for wireless communication with other nodes); and a local storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes the node to perform steps described herein (e.g., steps described herein with reference to the flow charts). In other embodiments, the node may be configured to perform steps described herein without the need for code. That is, for example, PC 702 may consist merely of one or more ASICs. Hence, the features of the embodiments described herein may be implemented in hardware and/or software.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for authentication and access control for one or more resources; comprising:
sending, from a service provider to a database, a first identity contract, wherein said first identity contract comprises one or more of an identity of said service provider and a credential reference of said service provider;
establishing a service relationship with a service user of said service provider; and
sending, from said service provider to said database, a service contract based on said service relationship, wherein said service contract comprises one or more of identification information regarding said service provider and said service user, and access information for said service provider and said service user, wherein
said database contains a second identity contract with respect to said service user,
said database has an exposure contract with respect to said one or more resources, and
said database is configured to authenticate and authorize said service contract based at least in part on said first and second identity contracts and said access information.

2. The method of claim 1, wherein said one or more resources comprise data, services configurations, and/or control APIs accessible to said service provider and/or service user.

3. The method of claim 1, wherein said access information comprises both authentication and authorization information.

4. The method of claim 1, wherein said database is a distributed database comprising a blockchain.

5. The method of claim 4, wherein said blockchain is a permissioned blockchain.

6. The method of claim 1, further comprising:
establishing said exposure contract.

7. The method of claim 1, wherein said database is configured to authenticate and authorize said service contract by verifying access with an outside service.

8. The method of claim 1, wherein said credential reference is public key or hash of a secret key.

9. The method of claim 1, wherein
said one or more resources belong to a data owner,
said data owner is separate from said service provider,
said database has an identity contract of said data owner, and
said exposure contract for said one or more resources is with respect to said data owner.

10. The method of claim 1, further comprising:
receiving, by said service provider from said service user, an invocation of service request for at least one of said resources; and
authenticating said service user with said database or an outside authentication and authorization service,
wherein said authenticating is based on one or more of an identity of said service user and said service contract.

11. The method of claim 10, further comprising:
initiating a service request, wherein said database is configured to perform the following based on said service request:
(i) authenticate the identity of said service provider,
(ii) authorize said service provider for the requested service,
(iii) execute said service contract,
(iv) execute said exposure contract, and
(v) register said request.

12. The method of claim 11, wherein said registering comprises logging one or more time, exit criteria, and a hash of an access token.

13. The method of claim 11, further comprising:
receiving, at said service provider from said database, a response to said service request.

14. The method of claim 13, wherein
said response comprises one or more an access token for said resource, requested data, the result of an action, log information, and charging instructions or
said response comprises a notification of denial.

15. (canceled)

16. The method of claim 1, wherein said service provider has said resource, and the method further comprises:
sending, from said service provider to said service user, said resource; and
registering said sending with said database.

17. The method of claim 1, wherein said service provider has said resource, and the method further comprises:
sending, from said service provider to said service user, an access token for said resource;
receiving, at said service provider from said service user, said token at a later time;
validating said access token;
sending, from said service provider to said service user, said resource; and registering said sending with said database.

18. The method of claim 1, wherein said service provider does not have said resource and the method further comprises:
sending a first fetching request for said resource to said data owner, wherein said data owner is configured to validate said first fetching request with said database;
receiving said resource from said data owner;
sending, from said service provider to said service user, said resource; and
registering said sending with said database.

19. The method of claim of claim 18, further comprising:
before sending said first fetching request to said data owner, receiving, at said service provider from said service user, a second fetching request for said resource;
validating said second fetching request; and
unpacking said second fetching request to generate said first fetching request.

20. The method of claim 1, wherein said service provider does not have said resource and the method further comprises:
sending, from said service provider to said service user, an access token, wherein said access token is configured to cause said data owner to perform the following upon receipt of said access token from said service user:
(i) validate said access token,
(ii) send said resource to said service user,
(iii) and register said sending in said database.

21-26. (canceled)

27. The method of claim 1, wherein said database is configured to perform the following based upon the receipt of a service initiation request from said service provider to enable said modification, creation, or deletion by said service user:
(i) verify that said service provider and said service user are associated with the contract.
(ii) verify that said request complies with one or more static rules and policies, and
(iii) verify that said request complies with one or more dynamic data conditions and policies.

28. (canceled)

29. (canceled)

30. (canceled)

31. A computer program product comprising a non-transitory computer readable medium storing computer instruction which, when executed by one or more processors of a node, cause the node to perform the method of claim 1.

32. A service provider node comprising:
a memory; and
processing circuitry coupled to the memory, wherein the service provider node is configured to perform the steps of claim 1.
